(19) United States
(12) Patent Application Publication
(10) Pub. No.: US 2009/0055515 A1
(43) Pub. Date: Feb. 26, 2009

(54) Facilitating distributed and redundant statistics collection

(75) Inventors: Wlodek Olesinski, Nepean (CA); Allan C. Cybulskie, Richmond (CA); Margaret Rachniowski, Ottawa (CA)

Correspondence Address: GALASSO & ASSOCIATES, LP, P.O. BOX 26503, AUSTIN, TX, 78755-0503, US

(73) Assignee: ALCATEL LUCENT

(21) Appl. No.: 11/894,386

(22) Filed: Aug. 21, 2007

(51) Int. Cl. G06F 15/177

(52) U.S. Cl. 709/220

(57) ABSTRACT

A method comprises a plurality of operations. An operation is performed for loading an entire configuration information dataset from a configuration information source onto a first collector system of each one of a plurality of collector groups. The configuration information at least partially defines a manner in which operational statistics for a network node are collected. An operation is performed for loading the entire configuration information dataset from the first collector system of each one of the collector groups onto a second collector system of a respective one of the collector groups after the entire configuration information dataset is loaded onto the first collector system thereof.

### FIELD OF THE DISCLOSURE

The disclosures made herein relate generally to data and communications networks and, more particularly, to facilitating collection of operational statistics in data or telecommunications networks.

### BACKGROUND

Operational statistics collected from network nodes are used for various important functions such as, for example, billing and network monitoring. These statistics are collected by systems known as collector groups. Each collector group has two redundant collector systems. A first one of the collector systems of a collector group (i.e., the first collector system) operates in an active mode collecting data from a subset of the network nodes. A second one of the collector systems of the collector group (i.e., the second collector system) operates in a standby mode and is kept in synchronization with the first collect system.

Each collector group has configuration information that pertains to the nodes from which it is collecting operational statistics and that defines which statistics need to be collected (e.g., in terms of on which equipment, services, etc statistics need to be collected). This configuration information is downloaded to the collector groups from a dedicated network entity such as, for example, a network management system (NMS) in response to configuration changes and network events known to the NMS. Normally, the information is conveyed to the collector groups as incremental updates to the existing information already stored by the collector group.

Occasionally, a refresh (i.e., reload) is performed in which all such configuration information stored on the NMS is sent to the collector groups in order to completely replace all existing configuration information on collector group systems. The problem with such a complete refresh is that the time needed to perform a refresh of the configuration information can be very long, especially when there are many collector groups involved. For example, it can take up to several hours to download all the necessary configuration information to a particular system of a collector group. In many cases, there can be anywhere from 10 to 20 collector groups, to which the configuration information is downloaded sequentially, thereby taking as much as 1 day or more for completion of the configuration information download. Such a significant amount of time being required to facilitate a refresh operation can result in an unacceptable delay in receipt of essential statistics such as, for example, statistics required for billing on newly configured services. Furthermore, the longer the refresh process takes, the more vulnerable it is to communication links failures and restarts, in some cases causing service interruptions, despite other features assisting in continuous stats collection.

Bulk refreshment of distributed data is unavoidable, as local repositories must be populated from scratch. Examples of scenarios in which a local repository must be populated from scratch include, but are not limited to, subsystem upgrades, new installations, massive reconfiguration and service disruption. Typically, local repositories are populated from a main data source.

Because of complex interactions between unsynchronized subsystems (e.g., network events concurrent to data reloads must be propagated as well), a natural and easiest procedure is to treat each collector as an independent entity. However, in large installations the delays introduced with such processing become prohibitive. For example, the existing approach is to download each system of a collector group and each collector group individually and in a sequential manner. There is no attempt made to expedite this process. Therefore, if there are 10 collector groups, with an active and standby collector system in each one, and it takes 2 hours to bulk refresh each collector system, it would take 40 hours to complete the refresh operation (i.e., 10 collector groups×2 collector systems per group×2 hours per collector system).

Therefore, facilitating bulk reloading of configuration information of collector groups in a manner that overcomes drawbacks associated with known approaches for facilitating bulk reloading of configuration information of collector groups would be advantageous, desirable and useful.

### SUMMARY OF THE DISCLOSURE

Embodiments of the present invention provide for an improved bulk refresh process that overcomes drawbacks associated with known approaches for facilitating bulk refreshment of configuration information of collector groups. One improvement is that, as opposed to the conventional approach of both collector systems in a collector group being refreshed (i.e., reloaded) from a common source (e.g., a NMS), embodiments of the present invention refresh a first collector system in a collector group from a primary source (e.g., a NMS) and refresh a second collector system in the collector group from the newly refreshed first collection system. In this manner, the time required for refreshing configuration information of a two-collector system collector group is reduced by 50%. Not only does this mean that statistics collection on new configuration information can start being gathered 50% sooner, but also that 50% less bandwidth resources are consumed by the refresh operation. Another area of improvement is that embodiments of the present invention allow the sequence in which the collector groups will be reloaded to be user-specified (e.g., by a customer, network operator, etc). Such user-specified refresh sequence enables the user to ensure that statistics will be collected as soon as possible on the most important configuration changes. For example, a user may desire that statistics be collected first for new equipment or services that have been provisioned on a particular network node.

In one embodiment of the present invention, a method comprises a plurality of operations. An operation is performed for loading an entire configuration information dataset from a configuration information source onto a first collector system of a first collector group. The configuration information at least partially defines a manner in which operational statistics for a network node are collected. An operation is performed for loading the entire configuration information dataset from the first collector system onto a second collector system of the first collector group after the entire configuration information dataset is loaded onto the first collector system.

In another embodiment of the present invention, a collector group comprises a first collector system and a second collector system accessible by the first collector system. The first collector system is configured for having an entire configuration information dataset loaded thereon from a configuration information source and for loading the entire configuration information dataset therefrom onto a second one of the collector systems after the entire configuration information dataset is loaded thereto. The configuration information at least partially defines a manner in which operational statistics for a network node are collected.

In another embodiment of the present invention, a network node comprises a collector system including a plurality of interconnected collector systems, a network management system connected to at least a first one of the collector systems and processor-executable instructions for causing configuration update functionality to facilitated. Processor-executable instructions are provided for causing an entire configuration information dataset to be loaded from the network management system onto the first one of the collector systems. The configuration information at least partially defines a manner in which operational statistics for a network node are collected. Processor-executable instructions are provided for causing the entire configuration information dataset to be loaded from the first one of the collector systems onto a second one of the collector systems after the entire configuration information dataset is loaded onto the first one of the collector systems.

These and other objects, embodiments, advantages and/or distinctions of the present invention will become readily apparent upon further review of the following specification, associated drawings and appended claims.

### BRIEF DESCRIPTION OF THE DRAWINGS

FIG. 1A is a diagrammatic view of a network node configured for facilitating configuration information reload functionality in accordance with a prior art implementation.

FIG. 1B is a diagrammatic view of a network node configured for facilitating configuration information reload functionality in accordance with an embodiment of the present invention.

FIG. 2 is a flow chart view showing a method for facilitating configuration information reload functionality in accordance with the present invention.

FIG. 3 is a flow chart view showing an operation for loading configuration information from a collector system in an active state onto a peer collector system in a standby state.

### DETAILED DESCRIPTION OF THE DRAWING FIGURES

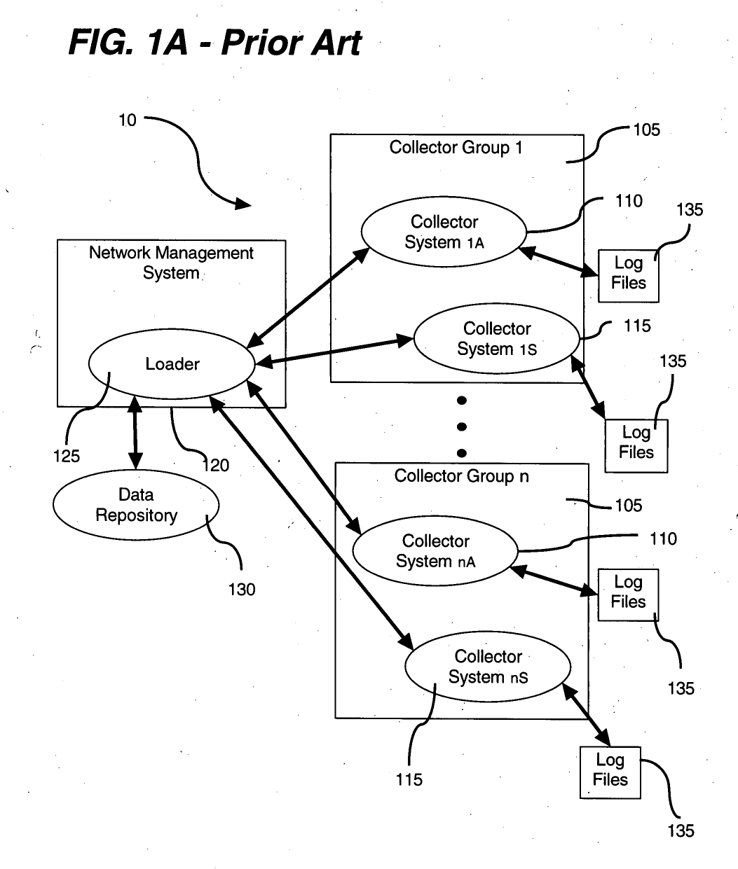

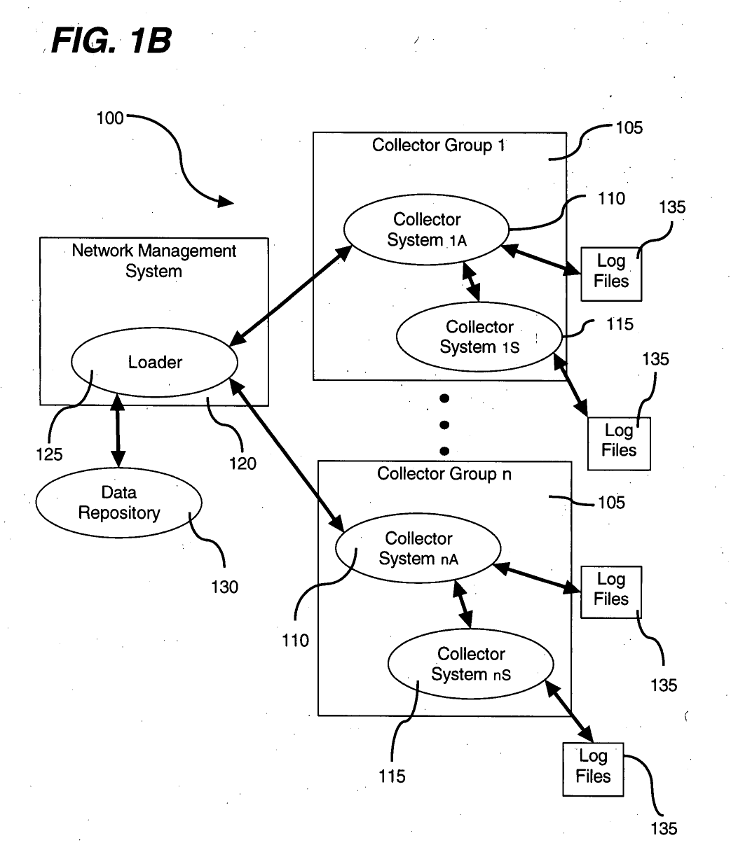

Referring to FIG. 1A, a network node 10 in accordance with a prior art implementation includes a plurality of collection groups 105. Each one of the collection groups 105 includes an active collection system 110 and a standby collection system 115. The first collector system 110 and the second collector system 115 of each one of the collector groups 105 are redundant (i.e., peer) collector systems of such collector group. The first collector system 110 is maintained in an active state and the second collector system 115 is maintained in a stand-by state while the first collector system 110 is in the active state. In a situation where the first collector system 110 is not able to facilitate required operational statistics collecting functionality, the second collector system 115 is switched to an active state, thereby allowing it to facilitate such required operational statistics collecting functionality.

The collector systems (110, 115) of each one of the collector groups 105 are each coupled to a network management system 120 through a loader 125. The loader 125 is coupled between the first collector system 110 of each one of the collector groups 105 and a data repository 130. In one embodiment, as shown in FIG. 1A, the loader 125 is a subsystem of a network management system 120 and the data repository is a standalone apparatus from the network management system 120. In other embodiments (not shown), the loader 125 is a standalone apparatus from the network management system 120 or is a subsystem of a system different than the network management system 120. In other embodiments (not shown), the data repository 130 is a subsystem of the network management system 120 or is a subsystem of a system different than the network management system 120.

The loader 125 facilitates loading on configuration information onto a first collector system 110 of one of the collection groups 105, followed by the loader 125 loading the same configuration information onto the second collector system 110 of the same collection group 105. The loader repeats this sequential load process for all of the collector groups 105 until all of the configuration information reloads are completed for all of the collector groups. As discussed above in reference to prior art implementations, the problem with implementing a complete reload (i.e., refresh) in this manner is that the time needed to perform such a complete reload of the configuration information can be very long, especially when there are many collector groups involved.

Referring to FIG. 1B in contrast to FIG. 1A, a network node 100 in accordance with the present invention has the same overall architectural structure as the network node 10 of FIG. 1A. The loader 125 facilitates loading on configuration information onto the first collector system 110 of each one of the collection groups 105. To this end, the loader 125 accesses configuration information from the data repository 130 and loads such configuration information onto the first collector system 110 of each one of the collection groups 105. In one embodiment, the data repository 130 is a database having the configuration information stored therein and accessible therefrom by the loader 125. The configuration information at least partially defines a manner in which operational statistics for a network node are collected by the collector system (110, 115). For example, such configuration information defines equipment, services, etc related to collection of operational statistics. The collected operational statistics are retained in (e.g., stored in) a respective log file 135. While a single log file is shown associated with each one of the collector systems in FIG. 1B, it is disclosed herein that a plurality of log files can be associated with each one of the collector systems.

It is disclosed herein that the configuration information loaded on the first collection system of one collection group will typically be, but not always, different than that configuration information loaded on the first collection system of a different collection group. Put differently, there will typically be distinct collectors and associated configuration information for each collection protocol.

The present invention advantageously, but optionally, allows the sequence in which the collector groups are reloaded to be specified by a user (e.g., a system administrator, a customer, a network operator, etc). This enables the user to ensure that statistics will be collected as soon as possible on the most important configuration changes (e.g., if new equipment or services are provisioned on a particular network node). In one embodiment, the network management system 120 is configured for allowing the user to configure the sequence in which the collector groups are reloaded.

In accordance with the present invention, the configuration information is loaded onto the first collector system 110 in each one of the collector groups 105 from a primary source (e.g., the data repository 130) via the loader 125 and the configuration information is loaded onto the second collector system 115 of each one of the collector groups 105 from the respective newly reloaded (i.e., refreshed) first collection system. In this manner, the present invention provides for distributed system optimization in well-defined and limited operations of bulk data exchange. Such distributed system optimization provides a number of advantages over prior art approaches for facilitating configuration information reload functionality. One specific advantage with respect to the embodiment disclosed in reference to FIG. 1B is a 50% time gain (i.e., refreshing only one collector system in a collector group). Another specific advantage with respect to the embodiment disclosed in reference to FIG. 1B is a 40% bandwidth gain (i.e., considering 50% gain in time (above) plus b/w savings through compressing data sent to update standby peer of a collector group). Still another specific advantage with respect to the embodiment disclosed in reference to FIG. 1B is 50% less load on the main source of data (i.e., because it only needs to send refreshed data to one peer system of a collector group).

Still referring to FIG. 1B, the arrows represent the relatively rare but unavoidable and costly operation of bulk data reload (i.e., refresh). Sequential reloads delay collector group by n-reloads, so it completes in 2nT time from the start time of the operation, where T is a single collector reload time, which in large networks is several hours long. Reloading of configuration information in accordance with the present invention cuts this delay in half. In addition, it offloads the loader (i.e., a central resource) and busy communication links between the loader and system collectors. Additional optimization is realized on operator requests, prioritizing collector groups (controlling order of the reloads).

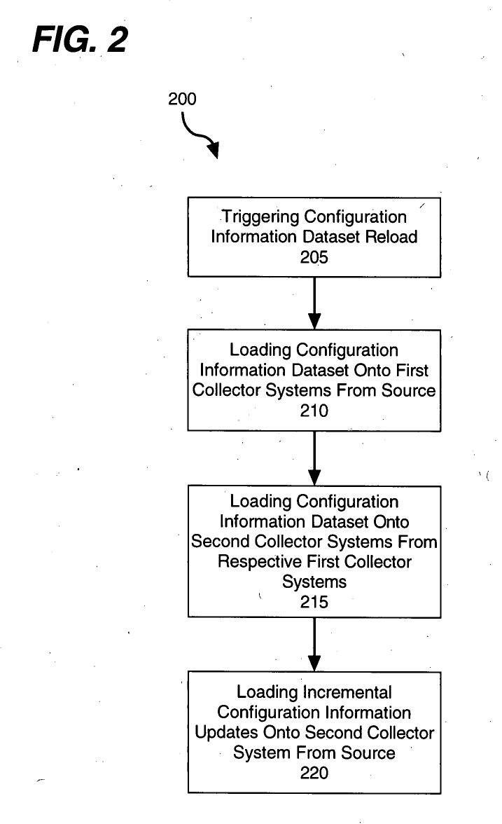

Referring now to FIG. 2, a method 200 is shown for facilitating configuration information reload functionality in accordance with an embodiment of the present invention. Configuration information in the context of FIG. 1B is preferably, but not necessarily, configuration information that at least partially defines a manner in which collector groups collect operational statistics for a network node. An operation 205 is performed for triggering configuration information reload functionality, which refers to reloading an entire configuration information dataset associated with each one of the collector groups. In one embodiment, such triggering is related to at least one of a user configuring the sequence in which the collector groups are reloaded, a user triggering such configuration information reload functionality via a network management system and/or such configuration information reload functionality being triggered in accordance with a pre-defined event (e.g., a pre-defined period of time passing since a prior reload, a predefined number of updated to the configuration information being made, etc). In response to the configuration information reload functionality being triggered, an operation 210 is performed for loading configuration information from a configuration information source (e.g., a data repository) onto a first collector system of a plurality of collector groups. As discussed above, in one embodiment, loading the configuration information onto each first collector system of a collector group includes loading the collector systems of the various collector groups in accordance with a user-defined or system defined load sequence. For example, the load sequence can be defined to ensure that statistics will be collected as soon as possible on the most important configuration changes. After a configuration information dataset is reloaded onto the first collector system of a respective one of the collector groups, an operation 215 is performed for loading that configuration information dataset from the first collector system onto a second collector system (i.e., peer/standby collector system to the first/active collector system) of that respective collector group. The intended end result of such a reload is for a redundant collector system pair in a network node to have functionally identical copies of pertinent configuration information. After the configuration information dataset is loaded from the first collector system onto a second collector system, an operation 220 is performed for loading incremental configuration information updated associated with a collector group directly onto the second collector system of that collector group. Thus, only configuration information reloads (i.e., the entire configuration information dataset) are made to a second collector system through a respective first collector system.

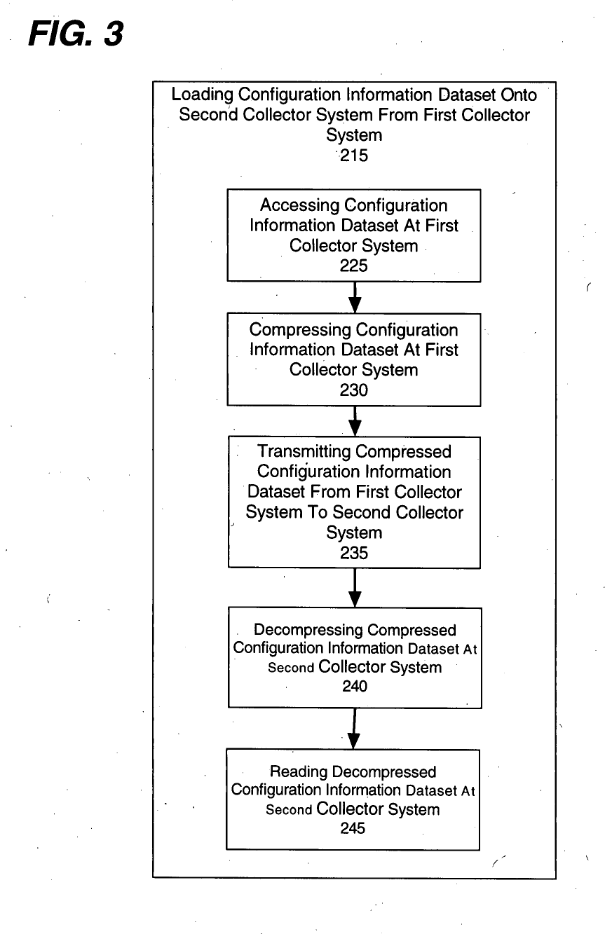

Referring now to FIG. 3, a preferred embodiment of the operation 215 for loading a configuration information dataset from the first collector system of a collector group onto the second collector system of the collector group. A step 225 is performed for accessing the configuration information dataset at first collector system (e.g., from virtual memory of the first collection system, a database of the first collection system, a network connection of the first collection system, etc), followed by a step 230 for compressing the configuration information dataset at a data repository associated at the first collector system. In response to compressing the configuration information dataset, a step 235 is performed for transmitting the compressed configuration information dataset from the first collector system for reception by the second collector system. Thereafter, a step 240 is performed for decompressing the compressed configuration information dataset at the second collector system in response to the compressed configuration information dataset being received by the second collector system. In response to decompressing the compressed configuration information, a step 245 is performed for reading the decompressed configuration information dataset at the second collector system.

Referring now to instructions processible by a data processing device, it will be understood from the disclosures made herein that methods, processes and/or operations adapted for carrying out configuration information reload functionality as disclosed herein are tangibly embodied by computer readable medium having instructions thereon that are configured for carrying out such functionality. In one specific embodiment, the instructions are tangibly embodied for carrying out the method 200 disclosed above. The instructions may be accessible by one or more data processing devices from a memory apparatus (e.g. RAM, ROM, virtual memory, hard drive memory, etc), from an apparatus readable by a drive unit of a data processing system (e.g., a diskette, a compact disk, a tape cartridge, etc) or both. Accordingly, embodiments of computer readable medium in accordance with the present invention include a compact disk, a hard drive, RAM or other type of storage apparatus that has imaged thereon a computer program (i.e., instructions) adapted for carrying out configuration information reload functionality in accordance with the present invention.

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A method, comprising:
loading an entire configuration information dataset from a configuration information source onto a first collector system of a first collector group, wherein said configuration information at least partially defines a manner in which operational statistics for a network node are collected; and
loading the entire configuration information dataset from the first collector system onto a second collector system of the first collector group after the entire configuration information dataset is loaded onto the first collector system.

2. The method of claim 1 wherein loading the entire configuration information dataset onto the second collector system includes:
accessing said configuration information dataset from a data repository of the first collector system;
compressing said configuration information dataset at the first collector system;
transmitting said compressed configuration information dataset from the first collector system for reception by the second collector system;
decompressing said compressed configuration information dataset at the second collector system in response to said compressed configuration information dataset being received by the second collector system; and
reading said decompressed configuration information dataset at the second collector system after decompressing said compressed configuration information dataset.

3. The method of claim 1 wherein:
the first collector system and the second collector system are redundant collector systems of a first collector group;
the first collector system is maintained in an active state; and
the second collector system is maintained in a stand-by state while the first collector system is in the active state.

4. The method of claim 1, further comprising:
loading incremental updates to said configuration information dataset onto the second collector system directly from the configuration information source after loading the entire configuration information dataset onto the second collector system.

5. The method of claim 1 wherein:
loading the entire configuration information dataset onto the first collector system of the first collector group includes loading the entire configuration information dataset onto the first collector system of the first collector group in accordance with a user-defined load sequence with respect to loading configuration information onto at least one other collector group.

6. The method of claim 5 wherein loading the entire configuration information dataset onto the second collector system includes:
accessing said configuration information dataset from a data repository of the first collector system;
compressing said configuration information dataset at the first collector system;
transmitting said compressed configuration information dataset from the first collector system for reception by the second collector system;
decompressing said compressed configuration information dataset at the second collector system in response to said compressed configuration information dataset being received by the second collector system; and
reading said decompressed configuration information dataset at the second collector system after decompressing said compressed configuration information dataset.

7. The method of claim 6, further comprising:
loading incremental updates to said configuration information dataset onto the second collector system directly from the configuration information source after loading the entire configuration information dataset onto the second collector system.

8. A collector group, comprising:
a first collector system; and
a second collector system accessible by the first collector system;
wherein the first collector system is configured for having an entire configuration information dataset loaded thereon from a configuration information source and for loading the entire configuration information dataset therefrom onto a second one of said collector systems after the entire configuration information dataset is loaded thereto;
wherein said configuration information at least partially defines a manner in which operational statistics for a network node are collected.

9. The collector group of claim 8 wherein being configured for loading the entire configuration information dataset onto the second collector system includes being configured for:
accessing said configuration information dataset from a data repository of the first collector system;
compressing said configuration information dataset at the first collector system;
transmitting said compressed configuration information dataset from the first collector system for reception by the second collector system;
decompressing said compressed configuration information dataset at the second collector system in response to said compressed configuration information dataset being received by the second collector system; and
reading said decompressed configuration information dataset at the second collector system after decompressing said compressed configuration information dataset.

10. The collector group of claim 8 wherein:
the first collector system is maintained in an active state; and
the second collector system is maintained in a stand-by state while the first collector system is in the active state.

11. The collector group of claim 8 wherein being configured for loading the entire configuration information dataset onto the first collector system includes being configured for loading the entire configuration information dataset onto the first collector system in accordance with a user-defined load sequence with respect to loading configuration information onto at least one other collector group.

12. The collector group of claim 11 wherein being configured for loading the entire configuration information dataset onto the second collector system includes being configured for:
accessing said configuration information dataset from a data repository of the first collector system;
compressing said configuration information dataset at the first collector system;
transmitting said compressed configuration information dataset from the first collector system for reception by the second collector system;
decompressing said compressed configuration information dataset at the second collector system in response to said compressed configuration information dataset being received by the second collector system; and
reading said decompressed configuration information dataset at the second collector system after decompressing said compressed configuration information dataset.

13. A network node, comprising:
a first collector system including a plurality of interconnected collector systems;
a network management system connected to at least a first one of said collector systems;
processor-executable instructions for causing an entire configuration information dataset to be loaded from the network management system onto the first one of said collector systems, wherein said configuration information at least partially defines a manner in which operational statistics for a network node are collected; and
processor-executable instructions for causing the entire configuration information dataset to be loaded from the first one of said collector systems onto a second one of said collector systems after the entire configuration information dataset is loaded onto the first one of said collector systems.

14. The network node of claim 13 wherein causing the entire configuration information dataset to be loaded from the first one of said collector systems onto a second one of said collector systems includes:
accessing said configuration information dataset from a data repository of the first collector system;
compressing said configuration information dataset at the first collector system;
transmitting said compressed configuration information dataset from the first collector system for reception by the second collector system;
decompressing said compressed configuration information dataset at the second collector system in response to said compressed configuration information dataset being received by the second collector system; and
reading said decompressed configuration information dataset at the second collector system after decompressing said compressed configuration information dataset.

15. The network node of claim 13 wherein:
said collector systems are redundant collector systems of a first collector group;
the first one of said collector systems is maintained in an active state; and
the second one of said collector systems is maintained in a stand-by state while the first one of said collector systems is in the active state.

16. The network node of claim 13, further comprising:
instructions for causing incremental updates to said configuration information dataset to be loaded onto the second one of said collector system directly from the network management system after loading the entire configuration information dataset onto the second one of said collector systems.

17. The network node of claim 13 wherein:
causing the entire configuration information dataset to be loaded onto the first collector system of the first collector group includes causing the entire configuration information dataset to be loaded onto the first collector system of the first collector group in accordance with a user-defined load sequence with respect to loading configuration information onto at least one other collector group.

18. The network node of claim 17 wherein causing the entire configuration information dataset to be loaded from the first one of said collector systems onto a second one of said collector systems includes:
accessing said configuration information dataset from a data repository of the first collector system;
compressing said configuration information dataset at the first collector system;
transmitting said compressed configuration information dataset from the first collector system for reception by the second collector system;
decompressing said compressed configuration information dataset at the second collector system in response to said compressed configuration information dataset being received by the second collector system; and
reading said decompressed configuration information dataset at the second collector system after decompressing said compressed configuration information dataset.

19. The network node of claim 18, further comprising:
instructions for causing incremental updates to said configuration information dataset to be loaded onto the second one of said collector system directly from the network management system after loading the entire configuration information dataset onto the second one of said collector systems.
